(19) United States
(12) Patent Application Publication
(10) Pub. No.: US 2026/0045018 A1
(43) Pub. Date: Feb. 12, 2026

(54) SYSTEM(S) AND METHOD(S) FOR UTILIZING GENERATIVE MODEL(S) TO GENERATE AND/OR CONTROL PERSONALIZED AVATAR(S)

(71) Applicant: GOOGLE LLC, Mountain View, CA (US)

(72) Inventors: Ágoston Weisz, Zurich (CH); Michael Andrew Goodman, Oakland, CA (US)

(21) Appl. No.: 18/798,108

(22) Filed: Aug. 8, 2024

(51) Int. Cl. G06T 13/40; G06F 40/40

(52) U.S. Cl. CPC G06T 13/40; G06F 40/40

(57) ABSTRACT

Implementations are directed to utilizing generative model(s) (GM(s)) to generate and/or control personalized avatar(s). Processor(s) of a system can receive vision data that captures a user and generate a personalized avatar of the user (e.g., a virtual three-dimensional representation of the user) based on the vision data. Further, the processor(s) can receive natural language instructions for controlling the personalized avatar, process, using the GM(s), at least an indication of the personalized avatar and the natural language instructions, determine generative data that characterizes the personalized avatar of the user performing a sequence of actions defined by the natural language instructions, and cause the generative data to be rendered at a client device of the user or an additional client device of the user or an additional user. The generative data can include, for example, generative video data, generative audio data, etc.

### BACKGROUND

Various generative models (GMs) have been proposed that can be used to process image content, audio content, natural language (NL) content and/or other input(s), to generate output that reflects generative content that is responsive to the input(s). As one example, stable diffusion models have been developed that can be used to process NL content and/or other input(s), to generate visual output that that reflects NL content and/or other content that is responsive to the input(s). As another example, large language models (LLM(s)) have been developed that can be used to process NL content and/or other input(s), to generate LLM output that that reflects NL content and/or other content that is responsive to the input(s).

Some GMs are capable of generating avatars in the form of three-dimensional representations of people, animals, animated objects, etc. However, these avatars typically do not reflect an actual human, such as a user that is interacting with the GMs. For example, generating a personalized avatar of actual human can present data privacy and data security issues since there are no/little guarantee that the user that generates the personalized avatar of the actual human is not doing so for a fraudulent and/or nefarious purpose. Further, these GMs that are capable of generating these personalized avatars offer no/little control over the personalized avatars. For example, these GMs typically output an image of the actual human in a unique environment (e.g., an image of the actual human on the surface of Mars), but fail to enable the user to control the personalized avatar with realistic generative video data (e.g., showing the actual human walking on the surface of Mars) and/or generative audio data (e.g., the personalized avatar talking while walking on the surface of Mars). Accordingly, there is a need in the art for GMs that not only generate personalized avatars in a manner that considers data privacy and data security, but also that enables users to subsequently control these personalized avatars in virtual environments.

### SUMMARY

Implementations described herein are directed to utilizing generative model(s) (GM(s)) to generate and/or control personalized avatar(s). Processor(s) of a system can receive vision data that captures a user and generate a personalized avatar of the user (e.g., a virtual three-dimensional representation of the user) based on the vision data. Further, the processor(s) can receive natural language instructions for controlling the personalized avatar, process, using the GM(s), at least an indication of the personalized avatar and the natural language instructions, determine generative data that characterizes the personalized avatar of the user performing a sequence of actions defined by the natural language instructions, and cause the generative data to be rendered at a client device of the user or an additional client device of the user or an additional user. The generative data can include, for example, generative video data, generative audio data, etc.

For example, assume that the system receives vision data that captures at least the user's face from various angles and that is generated via vision component(s) of the client device of the user. In this example, the system can process the vision data to generate an embedding of at least the user's face, and map the embedding to a generic avatar to generate the personalized avatar of the user. Prior to generating the personalized avatar, the system may determine whether the user is, in fact, authorized to cause the personalized avatar to be generated, such as by using various biometric authorization techniques to ensure the user that is captured in the vision data is the same user that provided the requested the personalized avatar be generated. Further assume that the system receives a document provided by the user along with natural language instructions that requests the system generate generative audiovisual content of the personalized avatar giving a presentation based on contents included in the document provided by the user. In this example, the system can process, using the GM, an indication of the personalized avatar, the natural language instructions, the document, and/or other context. Based on the processing using the GM, the system can generate the generative audiovisual content, such as an interactive video of the personalized avatar presenting topics covered in the document via generative audio data and as the personalized avatar is present in a virtual environment.

In various implementations, and prior to the system receiving the vision data, the system can train the GM, perform supervised fine-tuning of the GM, and perform reinforcement learning from human feedback (RLHF) for the GM. For example, during the initial training (sometimes referred to as “pre-training”), the system can process using the GM, a vast quantity of training instances, where each training instance includes a training three-dimensional representations of a human performing a sequence of training actions defined by training natural language instructions and includes the training natural language instructions. This training phase enables the GM to generalize facial expressions, emotions, movements, etc. using unsupervised or semi-supervised learning techniques. Further, during supervised fine-tuning of the GM, the system process, using the GM, a vast quantity of supervised fine-tuning instances, where each supervised fine-tuning instance includes a supervised fine-tuning three-dimensional representations of the human (or an additional human) performing a sequence of supervised fine-tuning actions defined by supervised fine-tuning natural language instructions, includes the supervised fine-tuning natural language instructions, and also include a supervised fine-tuning attention signal. This supervised fine-tuning phase enables the GM to focus on specific facial expressions, emotions, movements, etc., such as movement of fingers or other appendages, lip movement during speech, through utilization of the supervised fine-tuning attention signal and through using supervised learning techniques (e.g., where features of the predicted generative data generated using the GM is compared to features of ground truth data of the human or the additional human actually performing the supervised fine-tuning sequence of actions). Moreover, during RLHF of the GM, the system can incorporate feedback from a developer associated with the system to further fine-tune and refine the GM since a human is in the loop.

By using techniques described herein, one or more technical advantages can be achieved. As one non-limiting example, techniques described herein provide a single unified interface to enable generation of generative data in multiple modalities. For example, the generative data can include generative audio data that characterizes speech spoken by the personalized avatar, generative video data that characterizes movement of the personalized avatar, etc. Accordingly, rather than interacting with a first interface to cause the generative audio data to be generated, a second interface to cause the generative video data to be generated, etc., the user need only act with a single interface. As a result, a quantity of user inputs received at a client device is reduced, a quantity of instances of the user switching between software applications or tabs of web browser is reduced and/or eliminated, thereby conserving computational and/or network resources. As another non-limiting example, techniques described herein can utilize biometric authentication techniques to ensure the user captured in the vision data and the user requesting the personalized avatar be generated are, in fact, the same person, thereby mitigating and/or eliminating instances of personalized avatars being generated for fraudulent and/or nefarious purposes. As yet another non-limiting example, by training the GM, and performing the supervised fine-tuning of the GM and/or performing the RLHF of the GM as described herein, the GM is able to generalize facial expressions, emotions, movements, etc. in such a way that mitigates and/or eliminates follow-up inputs to cure inaccurate facial expressions, emotions, movements, thereby reducing a quantity of user inputs received at the client device, reducing a quantity of calls directed to the GM from the client device, etc., thereby conserving computational and/or network resources.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts a flowchart illustrating an example method of training a generative model (GM) to enable generation and control of personalized avatars, in accordance with various implementations.

FIG. 3 depicts a flowchart illustrating an example method of supervised fine-tuning (SFT) of a generative model (GM) to enable generation and control of personalized avatars, in accordance with various implementations.

FIG. 4 depicts a flowchart illustrating an example method of reinforcement learning from human feedback (RLHF) of a generative model (GM) to enable generation and control of personalized avatars, in accordance with various implementations.

FIG. 5 depicts a flowchart illustrating an example method of using a generative model (GM) to generate and control personalized avatars, in accordance with various implementations.

FIGS. 6A, 6B, and 6C depict various non-limiting examples of utilizing a generative model (GM) to generate personalized avatars, in accordance with various implementations.

FIGS. 7A, 7B, and 7C depict various non-limiting examples of utilizing a generative model (GM) to control personalized avatars, in accordance with various implementations.

FIG. 8 depicts an example architecture of a computing device, in accordance with various implementations.

### DETAILED DESCRIPTION

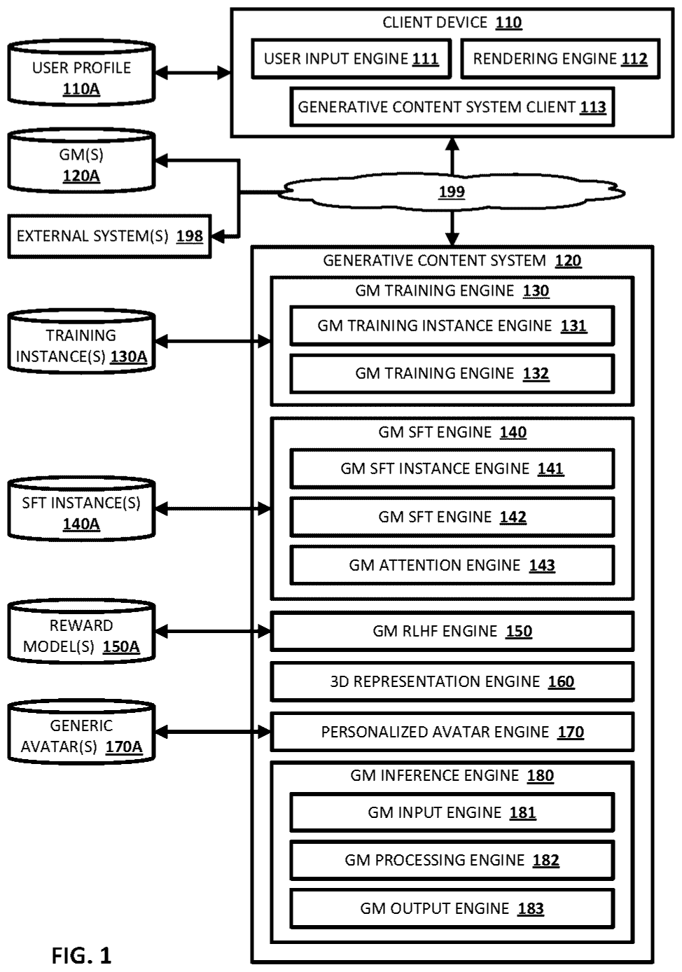

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant executing at least in part at the client device 110, an indication of actions to be performed by an automated assistant executing at least in part at the client device 110, notifications, selectable graphical elements, and/or any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to a generative content system 120 implemented remotely from the client device 110. The generative content system 120 can be implemented by, for example, a high-performance server, a cluster of high-performance servers, and/or any other computing device that is remote from the client device 110. The generative content system 120 includes, in various implementations, a generative model (GM) training engine 130, a GM supervised fine-tuning (SFT) engine 140, a GM reinforcement learning from human feedback (RLHF) engine 150, a three-dimensional (3D) representation engine 160, a personalized avatar engine 170, and a GM inference engine 180. The GM training engine 130 can include various sub-engines, such as a GM training instance engine 131 and a GM training engine 132. Further, the GM SFT engine 140 can include various sub-engines, such as a GM SFT instance engine 141, a GM SFT engine 142, and a GM attention engine 143. Moreover, the GM inference engine 180 can include various sub-engines, such as a GM input engine 181, a GM processing engine 182, and a GM output engine 183. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the generative content system 120 can access various databases and/or systems. For instance, the client device 110A can access user profile database 110A that stores user profile data as described herein and/or GM(s) database 120A that stores one or more GMs as described herein. Further, the client device 110A can interact with one or more external systems 198 as described herein. Also, for instance, the generative content system 120 can access the GM(s) database 120A that stores the one or more GMs as described herein, and can interact with the one or more external systems 198 as described herein. Moreover, the generative content system 120 can also access training instance(s) database 130A that stores training instances for training the one or more GMs stored in the GM(s) database 120A, SFT instance(s) database 140A that stores SFT instances for performing SFT for the one or more GMs stored in the GM(s) database 120A, reward model(s) database 150A that stores one or more rewards models for utilization in reinforcement learning of the one or more GMs stored in the GM(s) database 120A, generic avatar(s) database 170A that stores one or more generic avatars that can personalized to generate a personalized avatar of a user (e.g., the user of the client device 110). Although FIG. 1 is depicted with respect to certain databases and systems, it should be understood that is for the sake of example and is not meant to be limiting. For example, one or more of the databases and/or systems depicted in FIG. 1 can be combined and/or omitted.

Moreover, the client device 110 can execute the generative content system client 113. An instance of the generative content system client 113 can be an application that is separate from an operating system of the client device 110 (e.g., installed “on top” of the operating system)—or can alternatively be implemented directly by the operating system of the client device 110. The generative content system client 113 can communicate with the generative content system 120 via one or more of the networks 199 (e.g., as shown in FIG. 1). It should be understood that the generative content system client 113 can implement the generative content system 120 locally at the client device 110. However, it should also be understood that one or more aspects of the generative content system 120 can be implemented remotely from the client device 110 (e.g., exclusively at a high-performance server or cluster of high-performance servers), or at both remotely the generative content system 120 and locally the client device 110 (e.g., via the generative content system client 113) in a distributed manner. For example, the generative content system 120 can initially train a GM (e.g., using the GM training engine 130) and update the GM (e.g., using the GM SFT engine 140 and/or the GM RLHF engine 150), then the generative content system client 113 can implement the 3D representation engine 160, the personalized avatar engine 170, and the GM inference engine 180. Additionally, or alternatively, the generative content system 120 can implement the 3D representation engine 160 and the personalized avatar engine 170, but the generative content system client 113 can implement the GM inference engine 180.

Furthermore, the client device 110 and/or the generative content system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the generative content system 120 (e.g., over the one or more networks 199). As another example, a given client device can be utilized by multiple users in a shared setting (e.g., a group of users, a household, etc.).

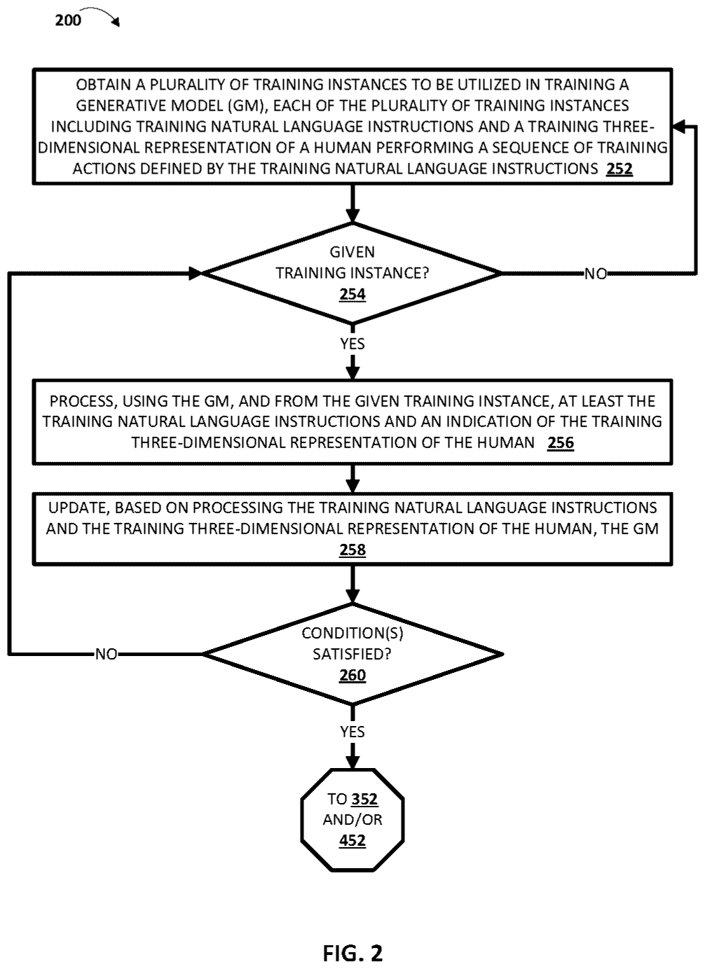

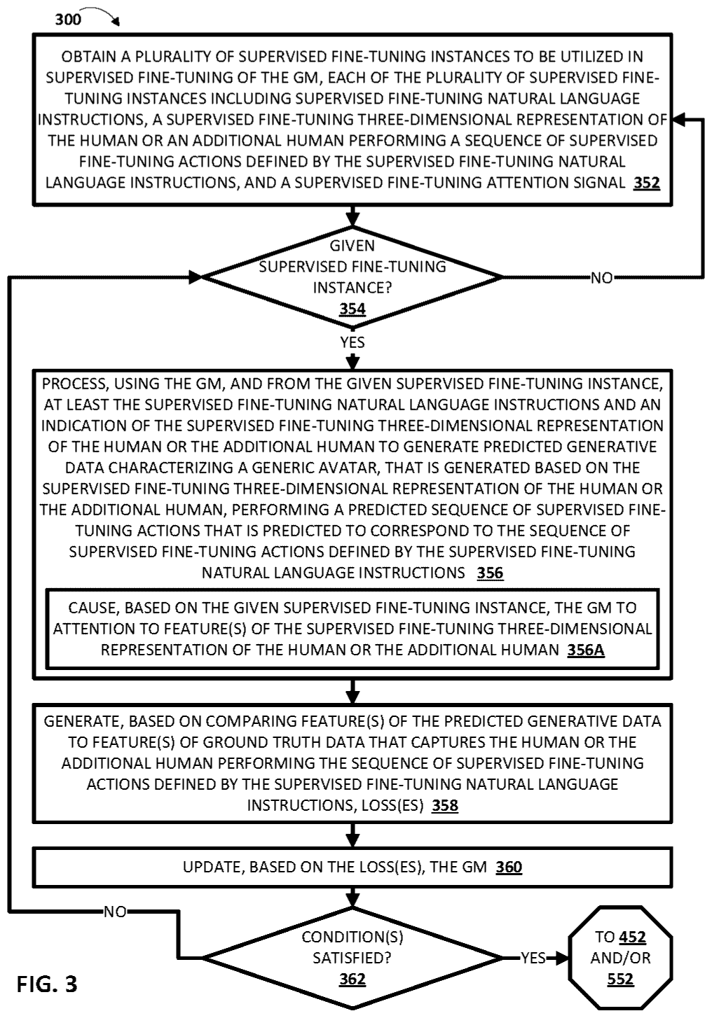

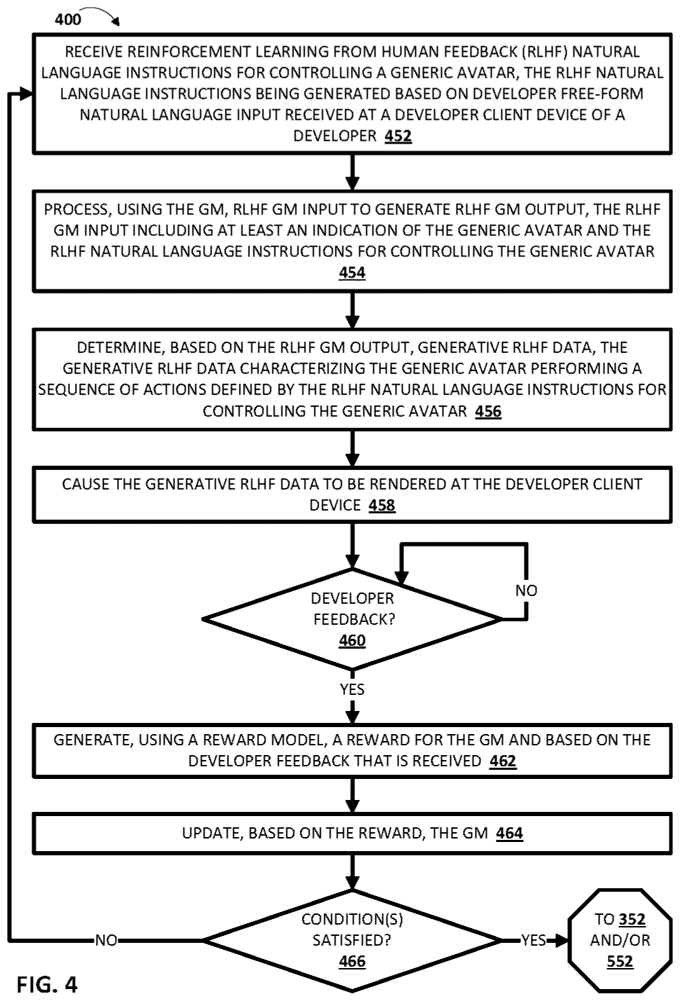

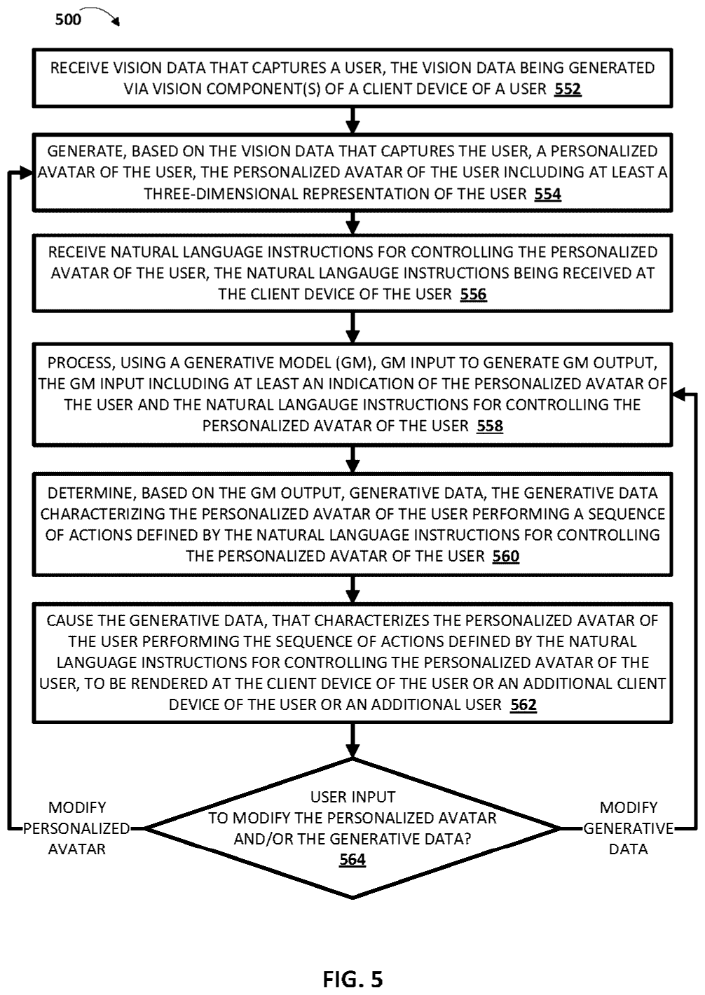

As described herein, the generative content system 120 can be utilized to initially train a GM (also referred to as “pre-training” a GM) to generate generative data characterizing generic and/or personalized avatars based on processing vision data capturing a human performing a plurality of actions that are defined by training natural language instructions and based on processing the training natural language instructions (e.g., as described with the respect to FIG. 2). Further, the generative content system 120 can be utilized to perform SFT of the GM to refine generation of generative data characterizing generic and/or personalized avatars based on processing vision data capturing a human performing a plurality of actions that are defined by SFT natural language instructions and based on processing the SFT natural language instructions, and/or attention generation of the generative data characterizing the generic and/or personalized avatars based on processing vision data capturing a human performing a plurality of actions that are defined by SFT natural language instructions and based on processing the SFT natural language instructions (e.g., as described with respect to FIG. 3). Additionally, or alternatively, the generative content system 120 can be utilized to perform RLHF of the GM to refine generation of generative data characterizing generic and/or personalized avatars based on processing vision data capturing a human performing a plurality of actions that are defined by RLHF natural language instructions, based on processing the RLHF natural language instructions, and based on developer feedback received from a developer associated with the generative content system 120, and/or attention generation of the generative data characterizing the generic and/or personalized avatars based on processing vision data capturing a human performing a plurality of actions that are defined by SFT natural language instructions, based on processing the SFT natural language instructions, and based on developer feedback received from a developer associated with the generative content system 120 (e.g., as described with respect to FIG. 4). By initially training the GM as described herein and performing SFT and/or RLHF on the GM, the generative content system 120 is not only configured to utilize the GM in generating a personalized avatar for the user of the client device (e.g., as described with respect to FIG. 5), but is also configured to utilize the GM to control the personalized avatar for the user of the client device based on natural language instructions received from the user of the client device 110 (e.g., as also described with respect to FIG. 5). Additional description of the training engine 130, the GM SFT engine 140, the GM RLHF engine 150, the 3D representation engine 160, the personalized avatar engine 170, and the GM inference engine 180 is provided herein (e.g., with respect to FIGS. 2, 3, 4, 5, 6A-6C, and 7A-7B).

As described herein, the GM that is being trained can be any sequence-to-sequence based machine learning models capable of generating generative vision data, generative audio data, generative textual data, and/or other forms of generative data. Some non-limiting examples of these sequence-to-sequence based machine learning models capable that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

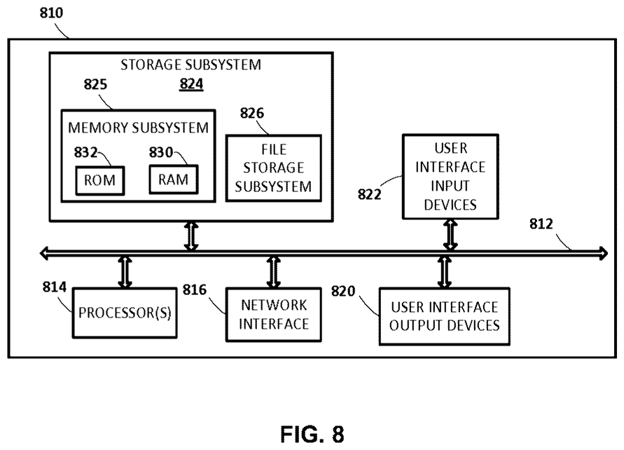

Turning now to FIG. 2, a flowchart illustrating an example method 200 of training a generative model (GM) to enable generation and control of personalized avatars is depicted. For convenience, the operations of the method 200 are described with reference to a system that performs the operations. This system of the method 200 includes at least one processor, memory, and/or other component(s) of computing device(s) (e.g., the generative content system 120 of FIG. 1, computing device 810 of FIG. 8, and/or other computing devices). Moreover, while operations of the method 200 are shown in a particular order, this is not meant to be limiting. One or more operations may be reordered, omitted, and/or added.

At block 252, the system obtains a plurality of training instances to be utilized in training a generative model (GM), each of the plurality of training instances including training natural language instructions and a training three-dimensional representation of a human performing a sequence of training actions defined by the training natural language instructions. For example, the system can cause the GM training instance engine 131 to obtain the plurality of training instances from the training instance(s) database 130A.

In some implementations, the GM training instance engine 131 can obtain vision data from a publicly available video library (e.g., YouTube® or the like) that includes the human performing various actions, such as the human walking, dancing, jumping, waving, performing sign language, talking with various facial expressions, and/or performing other actions. In these implementations, the GM training instance engine 131 can generate the plurality of training instances based on the vision data obtained from the publicly available video library, and store the plurality of training instances in the training instance(s) database 130A to enable the system to obtain the plurality of training instances therefrom. For example, the GM training instance engine 131 can process, using a three-dimensional modeling machine learning model or algorithm, the video data to generate the three-dimensional representation of the human performing the sequence of training actions. Further, the training instance engine 131 can process, using a captioning machine learning model (e.g., a visual language model (VLM) or the like), the video data to generate the training natural language instructions that describe the actions being performed by the human that are captured in the vision data. Additionally, or alternatively, the training instance engine 131 can receive developer input, from a developer that is associated with the system, that includes the training natural language instructions that describe the actions being performed by the human that are captured in the vision data. Put another way, in these implementations, the developer can describe the actions that are being performed in the vision data with varying levels of detail.

In additional or alternative implementations, the GM training instance engine 131 can obtain vision data from a curated video library that includes the human performing various actions, such as the human walking, dancing, jumping, waving, performing sign language, talking with various facial expressions, and/or performing other actions. Similar to the above mentioned implementations, the GM training instance engine 131 can generate the plurality of training instances based on the vision data obtained from the curated video library, and store the plurality of training instances in the training instance(s) database 130A to enable the system to obtain the plurality of training instances therefrom. For example, the GM training instance engine 131 can process, using a three-dimensional modeling machine learning model or algorithm, the video data to generate the three-dimensional representation of the human performing the sequence of training actions. Further, the training instance engine 131 the training instance engine 131 can receive developer input, from a developer that is associated with the system, that includes the training natural language instructions that describe the actions being performed by the human that are captured in the vision data. However, and in contrast with the aforementioned implementations, in these implementations, the developer may have initially provided the training natural language instructions that describe the various actions to be performed, and the vision data can capture the user performing the various actions (e.g., hence the phrase “curated” video library).

Notably, in various implementations, the training natural language instructions can be fairly detailed. For example, in implementations where the developer input is received (e.g., that describes the vision data obtained from the publicly available video library and/or that describes the various actions to be performed that is then captured in the vision data obtained from the curated video library), the developer input may not only described speech being spoken, emotions being expressed, and/or movements being performed, but the developer input may also provide detailed descriptions of transitions therebetween. This level of detailed description enables the GM, when trained based on the plurality of training instances, to better understand and generalize speech, emotions, and/or movements, and the transitions therebetween that are innately performed by humans.

At block 254, the system determines whether there is a given training instance for utilization in training the GM. If, at an iteration of block 254, the system determines that there is not a given training instance for utilization in training the GM, then the system returns to block 252 to obtain a plurality of additional training instances to be utilized in training the GM as described above. If, at an iteration of block 254, the system determines that there is a given training instance for utilization in training the GM, then the system proceeds to block 256.

At block 256, the system processes, using the GM, and from the given training instance, at least the training natural language instructions and an indication of the training three-dimensional representation of the human. At block 258, the system updates, based on processing the training natural language instructions and the training three-dimensional representation of the human, the GM. For example, the system can cause the training engine 132 to use unsupervised or self-supervised learning techniques to process, using the GM (e.g., stored in the GM(s) database 120A), at least the training natural language instructions and the indication of the training three-dimensional representation of the human and cause the GM to be updated based on the processing. For instance, the system can cause the training engine 132 to use unsupervised or self-supervised learning techniques to achieve some training objective such as video-text joint learning, conditioned masked language model, and video-text alignment to enable spatio-temporal reasoning such that the GM is able to understand and generalize speech, emotions, and/or movements, and the transitions therebetween.

At block 260, the system determines whether one or more conditions are satisfied. The one or more conditions can include, for example, whether the GM has been trained based on a threshold quantity of training instances, whether the GM has been trained for a threshold duration of time, whether the GM has achieved a threshold level of performance, whether the GM has consumed a threshold quantity of computational resources during training, and/or other conditions. If, at an iteration of block 260, the system determines that the one or more conditions are not satisfied, then the system returns to block 254 and continues with another iteration of the method 200 to further train the GM. For example, assuming that the system initially obtained the plurality of training instances, at least a given additional training instance should be available for further training the GM. Accordingly, the system can proceed with an additional iteration of the method 200 from black 254 in the same or similar manner described above. However, at some subsequent iteration of the method 200, the system may have to return to 252 to obtain a plurality of additional training instances prior to the one or more conditions being satisfied to continue training the GM.

If, at an iteration of block 260, the system determines that the one or more conditions are satisfied, then the system proceeds to block 352 and/or block 452. For example, the system can proceed to block 352 to perform supervised fine-tuning of the GM (e.g., as described with respect to FIG. 3). Additionally, or alternatively, the system can proceed to block 452 to perform RLHF for the GM (e.g., as described with respect to FIG. 4). In some implementations, the developer associated with the system can instruct the system to proceed to block 352 to perform supervised fine-tuning of the GM. In additional or alternative implementations, the developer associated with the system can instruct the system to proceed to block 452 to perform RLHF for the GM.

Turning now to FIG. 3, a flowchart illustrating an example method 300 of supervised fine-tuning of a generative model (GM) to enable generation and control of personalized avatars is depicted. For convenience, the operations of the method 300 are described with reference to a system that performs the operations. This system of the method 300 includes at least one processor, memory, and/or other component(s) of computing device(s) (e.g., the generative content system 120 of FIG. 1, computing device 810 of FIG. 8, and/or other computing devices). Moreover, while operations of the method 300 are shown in a particular order, this is not meant to be limiting. One or more operations may be reordered, omitted, and/or added.

At block 352, the system obtains a plurality of supervised fine-tuning (SFT) instances to be utilized in supervised fine-tuning of the GM, each of the plurality of supervised fine-tuning instances including supervised fine-tuning natural language instructions, a supervised fine-tuning three-dimensional representation of the human or an additional human performing a sequence of supervised fine-tuning actions defined by the supervised fine-tuning natural language instructions, and a supervised fine-tuning attention signal. The system can obtain the plurality of the supervised fine-tuning instances in the same or similar manner as described with respect to the plurality of training instances as described with respect to block 252 of the method 200 of FIG. 2, but by causing the GM SFT instance engine 141 to obtain the plurality of SFT instances from the SFT instance(s) database 140A. Notably, the supervised fine-tuning instances also include the supervised fine-tuning attention signal. Accordingly, the developer associated with the system can provide the supervised fine-tuning signal. The supervised fine-tuning attention signal can, for example, tell the system which features of the supervised fine-tuning three-dimensional representation of the human or the additional human to attention to while the sequence of supervised fine-tuning actions defined by the supervised fine-tuning natural language instructions is being performed. For example, the supervised fine-tuning attention signal can attention to particular facial movements while a user is speaking, while the user is expressing an emotion or feeling, etc. (e.g., attention to the user's lips while enunciating certain words or making certain faces, attention to the user's cheeks while enunciating certain words or making certain faces, attention to the user's eyebrows while enunciating certain words or making certain faces, and so on), attention to particular appendage movements while a user is speaking, while the user is expressing an emotion or feeling, while the user is walking or making other movements, etc. (e.g., attention to the user's hands or fingers while walking, attention to the user's legs while dancing, and so on).

At block 354, the system determines whether there is a given supervised fine-tuning instance for utilization in supervised fine-tuning of the GM. If, at an iteration of block 354, the system determines that there is not a given supervised fine-tuning instance for utilization in supervised fine-tuning of the GM, then the system returns to block 352 to obtain a plurality of additional supervised fine-tuning instances to be utilized in supervised fine-tuning of the GM. If, at an iteration of block 354, the system determines that there is a given supervised fine-tuning instance for utilization in supervised fine-tuning of the GM, then the system proceeds to block 356.

At block 356, the system processes, using the GM, and from the given supervised fine-tuning instance, at least the supervised fine-tuning natural language instructions and an indication of the supervised fine-tuning three-dimensional representation of the human or the additional human to generate predicted generative data characterizing a generic avatar, that is generated based on the supervised fine-tuning three-dimensional representation of the human or the additional human, performing a predicted sequence of supervised fine-tuning actions that is predicted to correspond to the sequence of supervised fine-tuning actions defined by the supervised fine-tuning natural language instructions. At sub-block 356A, the system causes, based on the given supervised fine-tuning instance, the GM to attention to one or more features of the supervised fine-tuning three-dimensional representation of the human or the additional human. At block 358, the system generates, based on comparing one or more features of the predicted generative data to one or more features of ground truth data that captures the human or the additional human performing the sequence of supervised fine-tuning actions defined by the supervised fine-tuning natural language instructions, one or more losses. At block 360, the system updates, based on the one or more losses, the GM.

Notably, in contrast with the training of the GM as described with respect to the method 200 of FIG. 2, in the supervised fine-tuning of the GM as described with respect to the method 300 of FIG. 3, supervised learning techniques are utilized to fine-tune the GM (e.g., hence the phrase “supervised” fine-tuning). For example, the system can cause the GM SFT engine 142 to process, using the GM, at least the supervised fine-tuning natural language instructions and the indication of the supervised fine-tuning three-dimensional representation of the human or the additional human to generate the predicted generative data characterizing the generic avatar performing the predicted sequence of supervised fine-tuning actions that is predicted to correspond to the sequence of supervised fine-tuning actions defined by the supervised fine-tuning natural language instructions. The predicted generative data can include, for example, predicted generative audio data characterizing synthesized speech audio data that captures speech spoken by the generic avatar that is specified by the supervised fine-tuning natural language instructions, predicted generative video data characterizing synthesized video data that captures movement by the generic avatar that is specified by the supervised fine-tuning natural language instructions, predicted generative image data characterizing synthesized image data that captures images of the generic avatar that is specified by the supervised fine-tuning natural language instructions, and/or other predicted generative data.

The one or more features of the predicted generative audio data can include, for instance, a predicted audio waveforms (e.g., including frequency, amplitude, duration, wavelength, etc. of the predicted generative audio data), predicted mel-frequency cepstral coefficients (e.g., representing timbral information of the predicted generative audio data), and/or other features of the predicted generative audio data. Accordingly, in implementations where the predicted generative data includes predicted generative audio data, the system can cause the GM SFT engine 142 to compare the one or more features of the predicted generative audio data to the one or more features of ground truth audio data (e.g., that captures the human or the additional human speaking) to generate the one or more losses. Thus, the system can cause the GM SFT engine 142 to update the GM by, for instance, backpropagating the one or more losses across the GM to update weights and/or other parameters of the GM.

The one or more features of the predicted generative video data or the predicted generative image data can include, for instance, predicted pixel values, predicted depth values, predicted objects or predicted object classifications, predicted textures, and/or other features of the predicted generative video data or the predicted generative image data. Accordingly, in implementations where the predicted generative data includes predicted generative video data or the predicted generative image data, the system can cause the GM SFT engine 142 to compare the one or more features of the predicted generative video data or the predicted generative image data to the one or more features of ground truth video data or ground truth image data (e.g., that captures the human or the additional human moving) to generate the one or more losses. Thus, the system can cause the GM SFT engine 142 to update the GM by, for instance, backpropagating the one or more losses across the GM to update weights and/or other parameters of the GM.

As noted above, the supervised fine-tuning attention signal can, for example, tell the system which features of the supervised fine-tuning three-dimensional representation of the human or the additional human to attention to while the sequence of supervised fine-tuning actions defined by the supervised fine-tuning natural language instructions is being performed. Accordingly, and while the GM SFT engine 142 is processing, using the GM, at least the supervised fine-tuning natural language instructions and the indication of the supervised fine-tuning three-dimensional representation of the human or the additional human to generate the predicted generative data, the system can cause the GM attention engine 143 to cause the GM to attention to the features of the supervised fine-tuning three-dimensional representation of the human or the additional human as specified by the supervised fine-tuning attention signal. For instance, the supervised fine-tuning attention signal can attention to lip movement or facial expressions as the supervised fine-tuning three-dimensional representation of the human or the additional human speaks, attention to arm, finger, or other appendage movements as the supervised fine-tuning three-dimensional representation of the human or the additional human moves through a virtual environment, and so on. By considering the supervised fine-tuning attention signal in processing the given supervised fine-tuning instance, the system causes the GM to generalize emotions, movements, feelings, etc., but also while focusing on specific features that are of particular importance in generating realistic generative data.

At block 362, the system determines whether one or more conditions are satisfied. The one or more conditions can include, for example, whether the GM has been fine-tuned based on a threshold quantity of supervised fine-tuning instances, whether the GM has been fine-tuned for a threshold duration of time, whether the GM has achieved a threshold level of performance, whether the GM has consumed a threshold quantity of computational resources during fine-tuning, and/or other conditions. If, at an iteration of block 362, the system determines that the one or more conditions are not satisfied, then the system returns to block 354 and continues with another iteration of the method 300 to perform further supervised fine-tuning of the GM. For example, assuming that the system initially obtained the plurality of supervised fine-tuning instances, at least a given additional supervised fine-tuning instance should be available for further supervised fine-tuning of the GM. Accordingly, the system can proceed with an additional iteration of the method 300 from black 354 in the same or similar manner described above. However, at some subsequent iteration of the method 300, the system may have to return to 352 to obtain a plurality of additional supervised fine-tuning instances prior to the one or more conditions being satisfied to continue training the GM.

If, at an iteration of block 362, the system determines that the one or more conditions are satisfied, then the system proceeds to block 452 and/or block 552. For example, the system can proceed to block 452 to perform RLHF for the GM (e.g., as described with respect to FIG. 4). Additionally, or alternatively, the system can proceed to block 552 to cause the GM to be utilized in generating a controlling a personalized avatar of a user (e.g., as described with respect to FIG. 5). In some implementations, the developer associated with the system can instruct the system to proceed to block 452 to perform RLHF for the GM. In additional or alternative implementations, the developer associated with the system can instruct the system to proceed to block 552 to cause the GM to be utilized in generating a controlling a personalized avatar of a user.

Turning now to FIG. 4, a flowchart illustrating an example method 400 of reinforcement learning from human feedback (RLHF) of a generative model (GM) to enable generation and control of personalized avatars is depicted. For convenience, the operations of the method 400 are described with reference to a system that performs the operations. This system of the method 400 includes at least one processor, memory, and/or other component(s) of computing device(s) (e.g., the generative content system 120 of FIG. 1, computing device 810 of FIG. 8, and/or other computing devices). Moreover, while operations of the method 400 are shown in a particular order, this is not meant to be limiting. One or more operations may be reordered, omitted, and/or added.

At block 452, the system receives reinforcement learning from human feedback (RLHF) natural language instructions for controlling a generic avatar, the RLHF natural language instructions being generated based on developer free-form natural language input received at a developer client device of a developer. For example, the RLHF natural language instructions can be provided by the developer as spoken input, typed input, and/or other forms of free-form natural language input that can be provided at the developer client device. Further, the RLHF natural language instructions can include any desired natural language instructions for controlling the generic avatar, such as for causing the generic avatar to speak certain speech, perform particular actions, and so on. In some implementations, the system can receive, along with the RLHF natural language instructions, document(s) provided by the developer (e.g., a slide presentation, a worksheet, etc.) that include content to be presented by the generic avatar and based on the RLHF natural language instructions and/or that enable content to generated and presented by the generic avatar and based on the RLHF natural language instructions. In some implementations, the developer can provide developer vision data that captures the developer and that is generated by vision component(s) of the developer client device. In these implementations, the system can cause the 3D representation engine 160 to generate a 3D representation of the developer (e.g., using the GM, using an additional machine learning (ML) model that is in addition to the GM, etc.), and can cause the personalized avatar engine 170 to map the 3D representation of the developer to the generic avatar (e.g., as described in more detail with respect to FIG. 5).

At block 454, the system processes, using the GM, RLHF GM input to generate RLHF GM output, the RLHF GM input including at least an indication of the generic avatar and the RLHF natural language instructions for controlling the generic avatar. At block 456, the system determines, based on the RLHF GM output, generative RLHF data characterizing the generic avatar performing a sequence of actions defined by the RLHF natural language instructions for controlling the generic avatar. For example, the system can cause the GM RLHF engine 150 to generate the RLHF GM input that includes the indication of the generic avatar, the RLHF natural language instructions for controlling the generic avatar, a conversational or dialog context if the RLHF natural language instructions are received as part of an ongoing conversation or dialog, and/or other content. Further, the RLHF GM output can include one or more probability distributions over a corresponding sequence of tokens, and the GM RLHF engine 150 can determine the generative RLHF data based on the one or more probability distributions over the corresponding sequences of tokens and using various decoding techniques.

For instance, in determining any generative audio data included in the RLHF generative data, the RLHF GM output can include a first probability distribution over a sequence of words or word units or over a sequence of phonemes or phonetic units. In instances where the first probability distribution is over the sequence of words or word units, the GM RLHF engine 150 can determine generative textual data corresponding to the generative audio data based on the first probability distribution, and utilize a text-to-speech model to generate the generative audio data and based on the generative textual data. In instances where the first probability distribution is over the sequence of phonemes or phonetic units, the GM RLHF engine 150 can determine the generative audio data directly based on the first probability distribution. Also, for instance, in determining any generative video data or generative image data included in the RLHF generative data, the RLHF GM output can include a second probability distribution over a sequence of pixels or pixel units. In these instances, the GM RLHF engine 150 can determine generative video data or generative image data directly based on the second probability distribution.

At block 458, the system causes the generative RLHF data to be rendered at the developer client device. For example, in implementations where the generative RLHF data includes generative audio data, the system can cause the generative audio data to be audibly rendered via speaker(s) of the developer client device. Also, for example, in implementations where the generative RLHF data includes generative video data or generative image data, the system can cause the generative video data or generative image data to be visually rendered, via a display of the developer client device, and using the generic avatar to perform action(s) indicated by the generative video data or the generative image data.

At block 460, the system determines whether developer feedback has been received. In some implementations, the developer feedback can be provided as binary feedback (e.g., a thumbs up or a thumbs down) to indicate whether or not the developer is satisfied with the generative data and based on the RLHF natural language instructions that were originally provided. In additional or alternative implementations, the developer feedback can be provided as additional developer free-form natural language input, via the developer client device, that indicates whether or not the developer is satisfied with the generative data and based on the RLHF natural language instructions that were originally provided, why or why not the developer is satisfied with the generative data and based on the RLHF natural language instructions that were originally provided, etc.

If, at an iteration of block 460, the system determines that developer feedback has not been received, then the system continues to monitor for developer feedback at block 460. In some implementations, the system may refrain from continuing to monitor for the developer feedback after a threshold duration of time has elapsed relative to the generative RLHF data being rendered. If, at an iteration of block 460, the system determines that developer feedback has been received, then the system proceeds to block 462.

At block 462, the system generates, using a reward model, a reward for the GM and based on the developer feedback that is received. At block 464, the system updates, based on the reward, the GM. For example, the system can cause the GM RLHF engine 150 to process, using a reward model stored in the reward model(s) database 150A, the developer feedback to generate the reward. Notably, the reward can be a positive reward (e.g., indicating the developer was satisfied with the generative data via a thumbs up or positive additional developer free-form natural language input) that reinforces the processing by the GM, or a negative reward (e.g., indicating the developer was no satisfied with the generative data via a thumbs down or negative additional developer free-form natural language input) that punishes the processing by the GM.

At block 466, the system determines whether one or more conditions are satisfied. The one or more conditions can include, for example, whether the GM has been updated based on a threshold quantity of RLHF interactions, whether the GM has been updated for a threshold duration of time of RLHF interactions, whether the GM has achieved a threshold level of performance, whether the GM has consumed a threshold quantity of computational resources during RLHF, and/or other conditions. If, at an iteration of block 466, the system determines that the one or more conditions are not satisfied, then the system returns to block 452 and continues with another iteration of the method 400 to perform further RLHF of the GM. For example, the system can receive additional RLHF natural language instructions for further controlling the generic avatar and continue with an additional iteration of the method 400.

If, at an iteration of block 466, the system determines that the one or more conditions are satisfied, then the system proceeds to block 352 and/or block 552. For example, the system can proceed to block 352 to perform supervised fine-tuning of the GM (e.g., as described with respect to FIG. 3). Additionally, or alternatively, the system can proceed to block 552 to cause the GM to be utilized in generating a controlling a personalized avatar of a user (e.g., as described with respect to FIG. 5). In some implementations, the developer associated with the system can instruct the system to proceed to block 352 to perform supervised fine-tuning of the GM. In additional or alternative implementations, the developer associated with the system can instruct the system to proceed to block 552 to cause the GM to be utilized in generating a controlling a personalized avatar of a user.

Turning now to FIG. 5, a flowchart illustrating an example method 500 of using a generative model (GM) to generate and control personalized avatars is depicted. For convenience, the operations of the method 500 are described with reference to a system that performs the operations. This system of the method 500 includes at least one processor, memory, and/or other component(s) of computing device(s) (e.g., the generative content system 120 of FIG. 1, the generative content system client 113 of FIG. 1, computing device 810 of FIG. 8, and/or other computing devices). Moreover, while operations of the method 500 are shown in a particular order, this is not meant to be limiting. One or more operations may be reordered, omitted, and/or added.

At block 552, the system receives vision data that captures a user, the vision data being generated via one or more vision component(s) of a client device of a user. In some implementations, the vision data that captures the user may be a three-dimensional representation of the user that was previously generated. In additional or alternative implementations, the vision data can be image(s) and/or video(s) of the user capturing at least a face of the user from different angles. In some versions of these implementations, the system can optionally instruct the user how to capture the image(s) and/or video(s) to ensure suitability of the vision data for subsequent generation of a personalized avatar of the user.

At block 554, the system generates, based on the vision data that captures the user, a personalized avatar of the user, the personalized avatar of the user including at least a three-dimensional representation of the user. For example, the system can cause the 3D representation engine 160 to process the vision data to generate the three-dimensional representation of the user, and generate, based on the three-dimensional representation of the user, an embedding of the user that corresponds to the three-dimensional representation. The embedding can be generated using the GM, an additional GM that is in addition to the GM, or an additional machine learning (ML) model that is non-generative. Further, the system can cause the personalized avatar engine 170 to map the embedding of the user that corresponds to the three-dimensional representation to a generic avatar (e.g., stored in the generic avatar(s) database 170A). By mapping the embedding of the user that corresponds to the three-dimensional representation to the generic avatar, the personalized avatar engine 170 effectively generates the personalized avatar of the user as a three-dimensional representation of the user.

At block 556, the system receives natural language instructions for controlling the personalized avatar of the user, the natural language instructions being received at the client device of the user. For example, the system can receive the natural language instructions as text-based input (e.g., typed input, touch input, etc.), speech-based input (e.g., spoken input, etc.), vision-based input (e.g., gesture input, sign language input, etc.).

At block 558, the system processes, using a generative model (GM), GM input to generate GM output, the GM input including at least an indication of the personalized avatar of the user and the natural language instructions for controlling the personalized avatar of the user. At block 560, the system determines, based on the GM output, generative data, the generative data characterizing the personalized avatar of the user performing a sequence of actions defined by the natural language instructions for controlling the personalized avatar of the user. For example, the system can cause the GM input engine 181 to generate the GM input that includes the indication of the personalized avatar, the natural language instructions for controlling the personalized avatar, a conversational or dialog context if the natural language instructions are received as part of an ongoing conversation or dialog, and/or other content. Further, the system can cause the GM processing engine 182 to process, using the GM, the GM input to generate the GM output. Moreover, the system can cause the GM output engine 183 to determine the GM output. The GM output can include one or more probability distributions over a corresponding sequence of tokens, and the GM output engine 183 can determine the generative data based on the one or more probability distributions over the corresponding sequences of tokens and using various decoding techniques.

For instance, in determining any generative audio data included in the generative data, the GM output can include a first probability distribution over a sequence of words or word units or over a sequence of phonemes or phonetic units. In instances where the first probability distribution is over the sequence of words or word units, the GM output engine 183 can determine generative textual data corresponding to the generative audio data based on the first probability distribution, and utilize a text-to-speech model to generate the generative audio data and based on the generative textual data. In instances where the first probability distribution is over the sequence of phonemes or phonetic units, the GM output engine 183 can determine the generative audio data directly based on the first probability distribution. Also, for instance, in determining any generative video data or generative image data included in the generative data, the GM output can include a second probability distribution over a sequence of pixels or pixel units. In these instances, the GM output engine 183 can determine generative video data or generative image data directly based on the second probability distribution.

At block 562, the system causes the generative data, that characterizes the personalized avatar of the user performing the sequence of actions defined by the natural language instructions for controlling the personalized avatar of the user, to be rendered at the client device of the user or an additional client device of the user or an additional user. For example, in implementations where the generative data includes generative audio data, the system can cause the generative audio data to be audibly rendered via speaker(s) of the client device. Also, for example, in implementations where the generative data includes generative video data or generative image data, the system can cause the generative video data or generative image data to be visually rendered, via a display of the developer client device, and using the personalized avatar to perform action(s) indicated by the generative video data or the generative image data.

At block 564, the system determines whether user input to modify the personalized avatar and/or the generative data has been received. For example, the user input can be text-based input (e.g., typed input, touch input, etc.), speech-based input (e.g., spoken input, etc.), vision-based input (e.g., gesture input, sign language input, etc.). In some implementations, the user input can include a request to modify the personalized avatar, such as user input that requests clothes of the personalized avatar be changes, a hairstyle of the personalized avatar be changed, that the personalized avatar have glasses or a hat, and/or any other request to modify the appearance of the personalized avatar characterized by the generative data. In some implementations, the user input can include a request to modify sequence of actions performed by the personalized avatar, such as modifying speech, expressions, movements, emotions, and/or any other request to modify the sequence of actions characterized by the generative data

If, at an iteration of block 564, the system determines that user input to modify the personalized avatar has been received, then the system returns to block 554. In these implementations, the system can re-generate the personalized avatar of the user and based on the user input that was received at block 564. The system can proceed with an additional iteration of the method 500 of FIG. 5. If, at an iteration of block 564, the system determines that user input to modify the generative data has been received, then the system returns to block 558. In these implementations, the system can re-generate the generative data and based on the user input that was received at block 564. The user can continue interacting with the system to further personalize the personalized avatar and/or to continue modifying the generative data as desired.

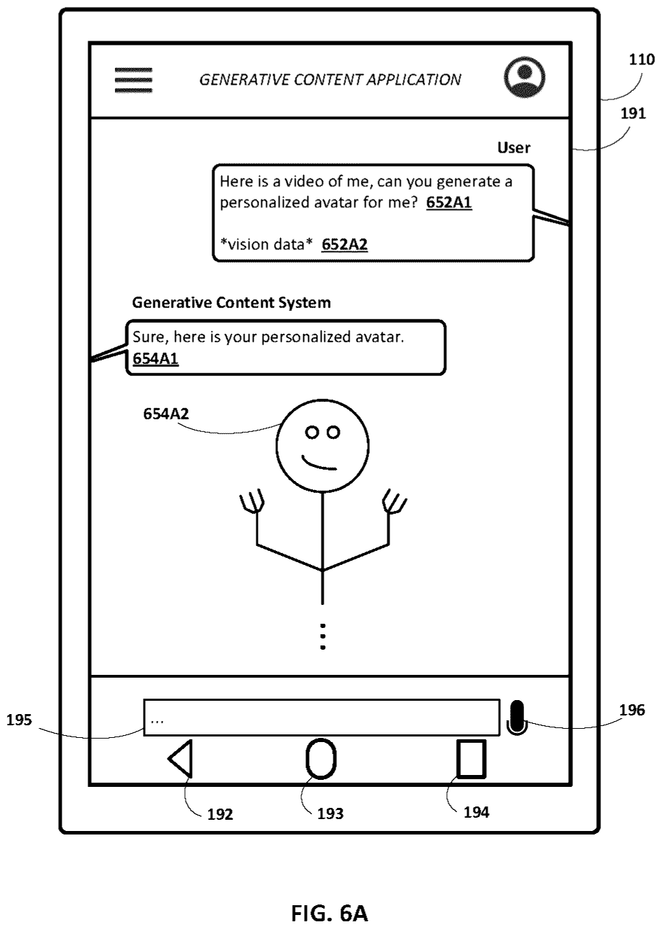

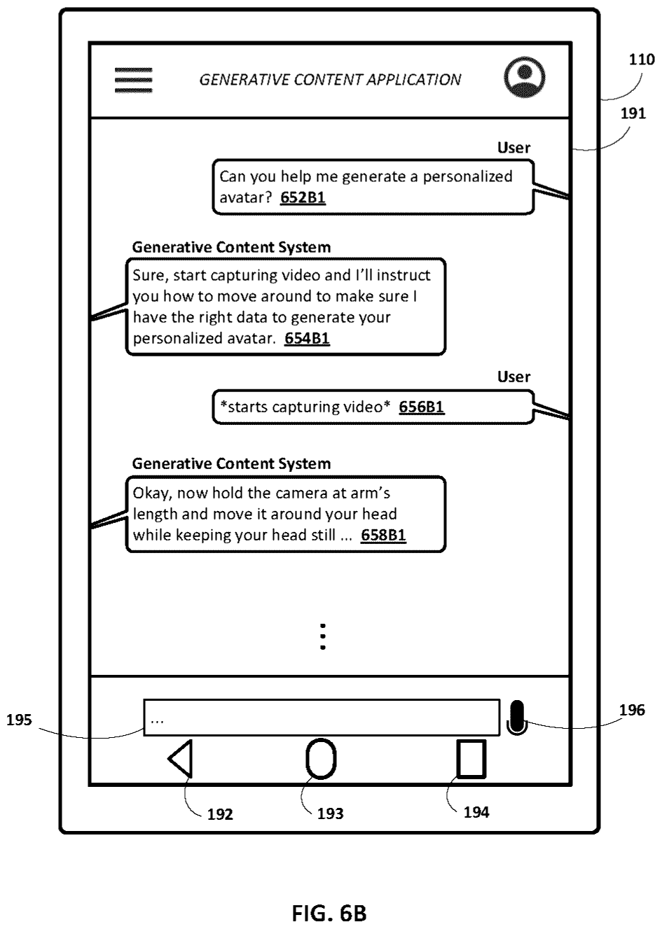

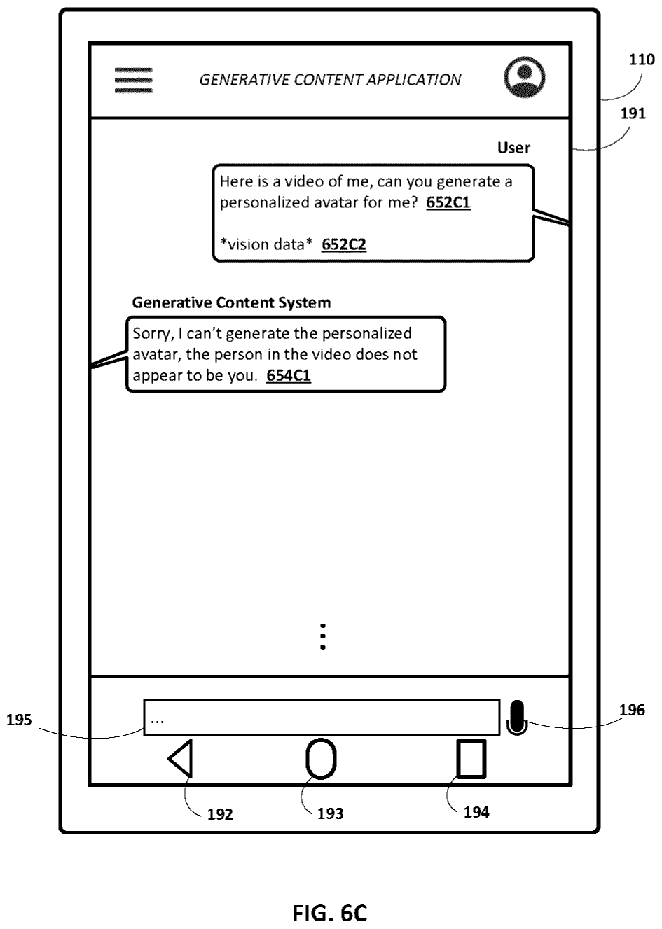

Turning now to FIGS. 6A, 6B, and 6C, various non-limiting examples of utilizing a generative model (GM) to generate personalized avatars are depicted. FIGS. 6A, 6B, and 6C each depict a client device 110 (e.g., an instance of the client device 110 from FIG. 1) having a display 191. Although the client device 110 of FIGS. 6A, 6B, and 6C is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 191 of the client device 110 in FIGS. 6A, 6B, and 6C further includes a textual input interface element 195 that the user may select to generate user input via a keyboard (virtual or real) or other touch and/or typed input, and a spoken input interface element 196 that the user may select to generate user input via microphone(s) of the client device 110. In some implementations, the user may generate user input via the microphone(s) without selection of the spoken input interface element 196. For example, active monitoring for audible user input via the microphone(s) may occur to obviate the need for the user to select the spoken input interface element 196. In some of those and/or in other implementations, the spoken input interface element 196 may be omitted. Moreover, in some implementations, the textual input interface element 195 may additionally and/or alternatively be omitted (e.g., the user may only provide audible user input). The display 191 of the client device 110 in FIGS. 6A, 6B, and 6C also includes system interface elements 192, 193, 194 that may be interacted with by the user to cause the client device 110 to perform one or more actions.

Referring specifically to FIG. 6A, for the sake of example, assume that a user of the client device 110 accesses a generative content application that is accessible by the client device 110 and provides user input that includes text 652A1 of “Here is a video of me, can you generate a personalized avatar for me?” and vision data 652A2 capturing the video referenced by the user in the text 652A1. In this example, a generative content system (e.g., the generative content system 120 of FIG. 1) that is accessible by the generative content application can generate a personalized avatar 654A2 for the user (e.g., as described with respect to the method 500 of FIG. 5), and optionally provide output 654A1 of “Sure, here is your personalized avatar”. Although the user proactively provided the vision data 652A2, it should be understood that is for the sake of example and is not meant to be limiting.

For example, and referring specifically to FIG. 6B, for the sake of example, instead assume that the user of the client device 110 provides user input that includes text 652B1 of “Can you help me generate a personalized avatar” and without proactively providing any vision data. In this example, the generative content system can provide output 654B1 of “Sure, start capturing video and I'll instruct you how to move around to make sure I have the right data to generate your personalized avatar”. Accordingly, and assuming the user starts capturing video as indicated at 656B1, the generate content system can provide additional output 658B1 of “Okay, now hold the camera at arm's length and move it around your head while keeping your head still . . . ”, and optionally additional instructions. Based on the video, the generative content system can then generate the personalized avatar for the user (e.g., as described with respect to the method 500 of FIG. 5).

While the user can interact with the generative content system in various manners to generate the personalized avatar, the generative content system can also employ various mechanisms to mitigate and/or eliminate instances of fraud or nefarious activities. For example, and referring specifically to FIG. 6C, for the sake of example, again assume that the user of the client device 110 provides user input that includes text 652C1 of “Here is a video of me, can you generate a personalized avatar for me?” and vision data 652C2 capturing the video referenced by the user in the text 652C1. However, in this example, and in contrast with FIGS. 6A and 6B, further assume that the vision data 652C2 capturing the video referenced by the user in the text 652C1 includes another user (i.e., not the user of the client device 110). Accordingly, in this example, the generative content system (e.g., the generative content system 120 of FIG. 1) that is accessible by the generative content application can provide output 654C1 of “Sorry, I can't generate the personalized avatar, the person in the video does not appear to be you”.

In the example of FIG. 6C (and in the examples of FIGS. 6A and 6C), the generative content system or other component(s) of the client device 110 (e.g., an automated assistant that is accessible at the client device 110) can, prior to generating any personalized avatar, determine whether the user is authorized to generate the personalized avatar. For instance, the personalized avatar may only be generated in response to determining that the user that provided the user input is the same user that is captured in the vision data. The generative content system or other component(s) of the client device 110 can determine whether the user is authorized to generate the personalized avatar based on, for instance, biometric data associated with the user of the client device 110 (e.g., stored in the user profile database 110A). The biometric data associated with the user of the client device 110 can include, for instance, a faceprint of the user of the client device 110, a voiceprint of the user of the client device 110, a thumbprint of the user of the client device 110, etc. Accordingly, in response to the vision data being provided that allegedly captures the user of the client device 110, the generative content system or other component(s) of the client device 110 can compare the faceprint of the user of the client device 110 to a faceprint generated based on the vision data (or additional vision data captured in response to the user input being provided) to determine whether the user that provided the user input is the same user that is captured in the vision data. Additionally, or alternatively, the generative content system or other component(s) of the client device 110 can request that the user speak and/or request that the user direct a thumb or other finger to a particular sensor of the client device 110 to authorize the user prior to generating the personalized avatar. In this way, the generative content system or other component(s) of the client device 110 can ensure that the person requesting that the personalized avatar be generated is, in fact, the same user that provided the user input, thereby eliminating and/or mitigating instances in which the personalized avatar is utilized for fraudulent and/or nefarious activities.

Although the examples of FIGS. 6A-6C are described with respect to the user interacting with the generative content system via the generative content application, it should be understood that is for the sake of example and is not meant to be limiting. Rather, it should be understood that that the user may be able to access the generative content system via a web browser or other component(s) of the client device 110 (e.g., an automated assistant that integrates one or more aspects of the generative content system). Further, although the examples of FIG. 6A are described with respect to the user causing the personalized avatar to be generated and without providing any natural language instructions for controlling the personalized avatar, it should be understood that is for the sake of example and to illustrate various techniques for how the personalized avatar can be generated. Rather, it should be understood that the natural language instructions for controlling the personalized avatar can be provided along with the user input of FIGS. 6A and/or 6B such that generative data can be generated using a single call to the GM.

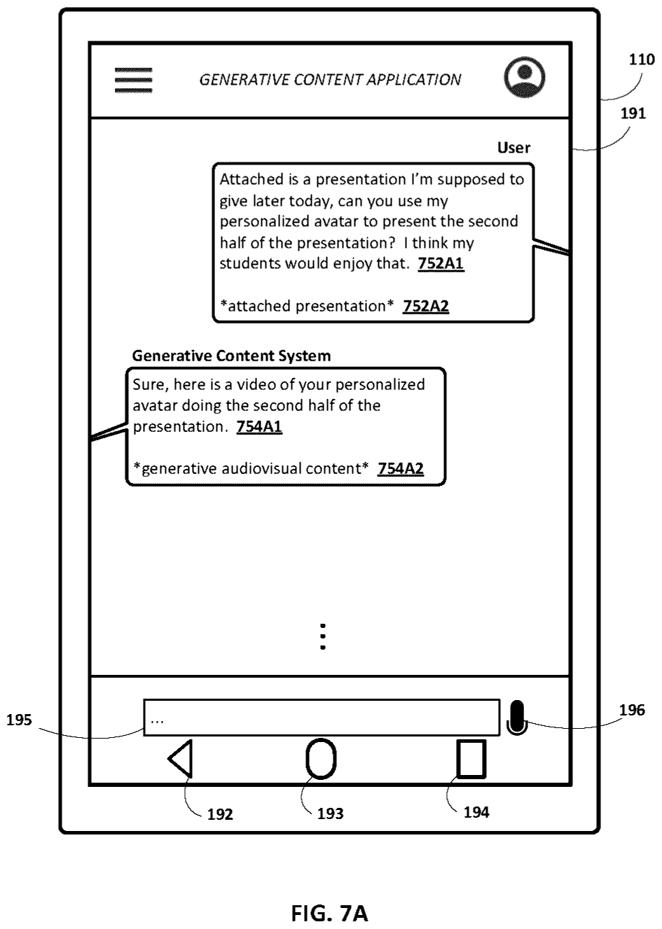

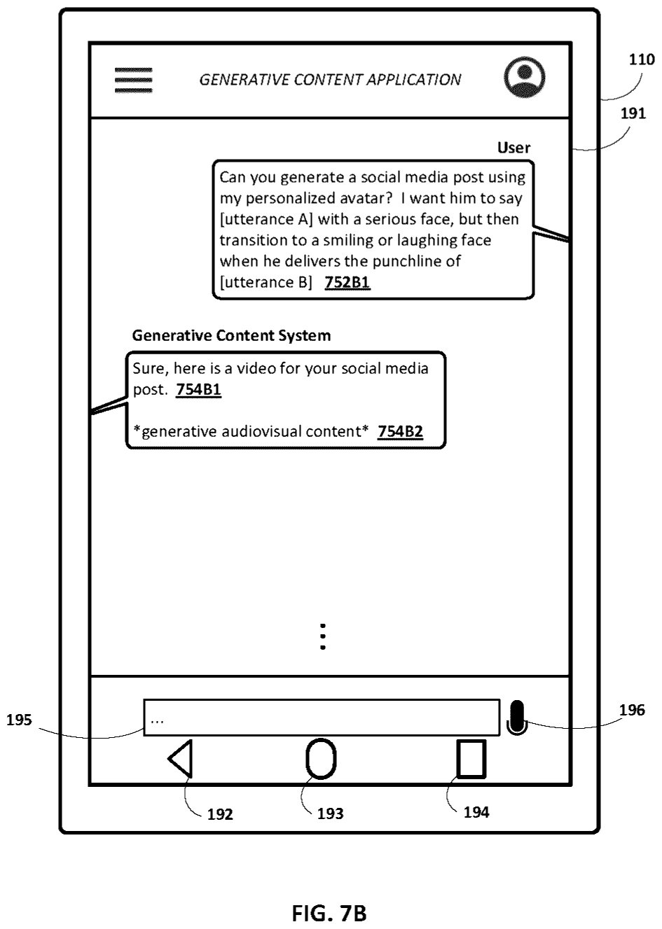

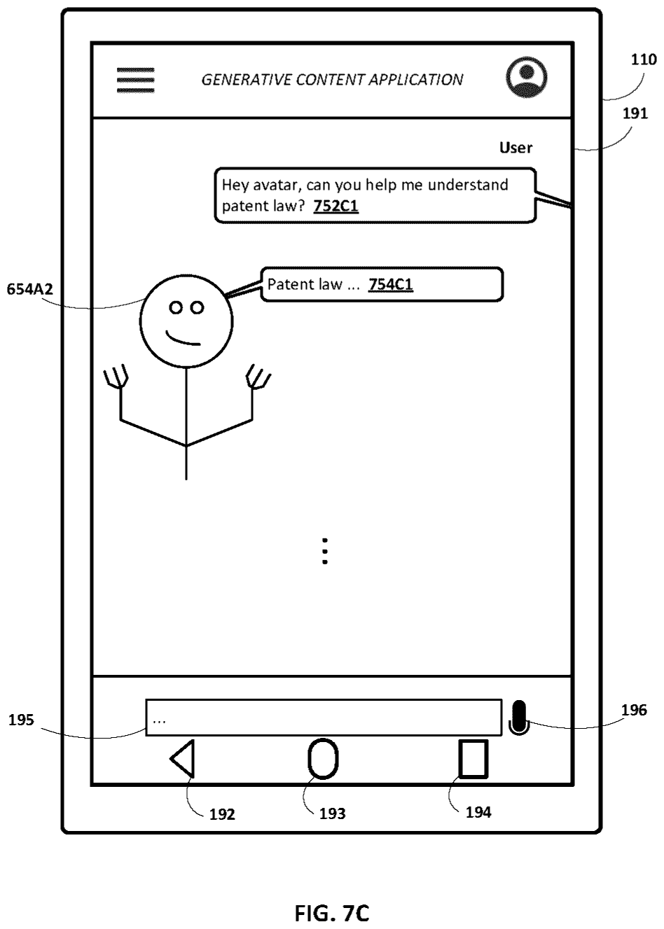

Turning now to FIGS. 7A, 7B, and 7C, various non-limiting examples of utilizing a generative model (GM) to control personalized avatars are depicted. FIGS. 7A, 7B, and 7C depict the client device 110 having the display 191 from FIGS. 6A, 6B, and 6C along with the same interface elements 192, 193, 194, 195, and 196. Similar to FIGS. 6A, 6B, and 6C, although the client device 110 of FIGS. 7A, 7B, and 7C is depicted as a mobile phone, it should be understood that is not meant to be limiting. Further, and for the sake of example throughout FIGS. 7A, 7B, and 7C, assume that a personalized avatar for a user of the client device 110 is already generated (e.g., as described with respect to FIGS. 6A and/or 6B) and based on the user interacting with the generative content application.

Referring specifically to FIG. 7A, for the sake of example, further assume that that the user of the client device 110 provides user input that includes text 752A1 of “Attached is a presentation I'm supposed to give later today, can you use my personalized avatar to present the second half of the presentation? I think my students would enjoy that” and a presentation as indicated at 752A2 referenced by the user in the text 752A1. In this example, a generative content system (e.g., the generative content system 120 of FIG. 1) that is accessible by the generative content application can process, using the GM, an indication of the personalized avatar (e.g., an embedding of the personalized avatar) generated as described with respect to FIGS. 6A and/or 6B, the natural language instructions provided in the text 752A1, the presentation uploaded by the user as indicated at 752A2, and/or other context or content. Based on this processing, the generative content system can provide output that includes generative audiovisual content 754A2 of the personalized avatar giving the second half of the presentation as specified by the natural language instructions, and optionally provide output 754A1 of “Sure, here is a video of your personalized avatar doing the second half of the presentation”.

In this example, the natural language instructions included in the text 752A1 request that the personalized avatar present the second half of the presentation provided by the user. Accordingly, the generative audiovisual content can include, for instance, generative audio data for each slide of the second half of the presentation. The generative audio data can characterize, for example, text included each slide of the second half of the presentation, image(s) (or video(s), gif(s), emoji(s), etc.) for each slide of the second half of the presentation, speaker notes for each slide of the second half of the presentation, and so on. Further, the generative audiovisual content can include, for instance, generative vision data for each slide of the second half of the presentation. The generative vision data can characterize, for example, the personalized avatar speaking the generative audio data, hand movements of the personalized avatar while speaking the generative audio data, face movements of the personalized avatar while speaking the generative audio, body movements of the personalized avatar while speaking the generative audio and so on. Notably, the generative audio data and the generative vision data need not be synchronized through any post-processing steps by virtue of the GM is trained (e.g., as described with respect to FIGS. 2, 3, and 4). However, the generative content system can analyze the generative data to verify that is synchronized prior to causing the generative audiovisual content to be rendered for presentation to the user.

In some implementations, and in response to the generative data being generated, it can be automatically rendered at the client device 110. For example, in response to the generative audiovisual content being generated, it can be visually and/or audibly rendered at the client device 110. In additional or alternative implementations, and in response to the generative data being generated, it may only be rendered at the client device 110 based on additional user input being received to cause it to be rendered. For example, in response to the generative audiovisual content being generated, a selectable icon can be provided that, when selected (e.g., via spoken input, touch input, etc.), can cause the generative audiovisual content to be visually and/or audibly rendered at the client device 110. In additional or alternative implementations, and in response to the generative data being generated, it may be automatically transmitted to an additional client device that is in addition to the client device 110. For example, in the example of FIG. 7A, the user indicated that they will be giving a presentation later that day. Accordingly, the generative data may be automatically transmitted to an additional client device of the user, such as a desktop computer or laptop computer from which the user is likely to give the presentation.

As another example, and referring specifically to FIG. 7B, for the sake of example, instead assume that that the user of the client device 110 provides user input that includes text 752B1 of “Can you generate a social media post using my personalized avatar? I want him to say [utterance A] with a serious face, but then transition to a smiling or laughing face when he delivers the punchline of [utterance B]”. In this example, the generative content system that is accessible by the generative content application can process, using the GM, an indication of the personalized avatar (e.g., an embedding of the personalized avatar) generated as described with respect to FIGS. 6A and/or 6B, the natural language instructions provided in the text 752B1, and/or other context or content. Based on this processing, the generative content system can provide output that includes generative audiovisual content 754B2 of the personalized avatar for the social media post as specified by the natural language instructions, and optionally provide output 754B1 of “Sure, here is a video for your social media post”.

In this example, the natural language instructions included in the text 752B1 request that the personalized avatar speak a certain series of utterances (e.g., utterance A and then utterance B) while exuding certain facial expressions as the personalized avatar speaks the certain series of utterances. Accordingly, the generative audiovisual content can include, for instance, generative audio data that characterizes utterance A and utterance B and generative vision data that characterizes the facial expressions throughout the certain series of utterances. In addition to the generative audiovisual content being rendered as described above with respect to FIG. 7A, the generative audiovisual content can additionally, or alternatively, be shared with a social media application to enable the user to quickly and efficiently share the social media post as desired.

As another example, and referring specifically to FIG. 7C, for the sake of example, instead assume that that the user of the client device 110 provides user input that includes text 752C1 of “Hey avatar, can you help me understand patent law?”. In this example, the generative content system that is accessible by the generative content application can process, using the GM, an indication of the personalized avatar (e.g., an embedding of the personalized avatar) generated as described with respect to FIGS. 6A and/or 6B, the natural language instructions provided in the text 752C1, and/or other context or content. Based on this processing, the generative content system can provide output 754C1 that is spoken (or rendered as text) as if the user is interacting with the personalized avatar 652A2.

In this example, the natural language instructions included in the text 752C1 request that the personalized avatar 654A2 directly interact with the user and based on the natural language instructions included in the text 752C1. Accordingly, the generative audiovisual content can include, for instance, generative audio data that characterizes the personalized avatar 654A2 speaking about patent law and generative video data that characterizes the personalized avatar 654A2 moving and dancing with excitement while discussing all things related to patent law with the user.

Similar to the examples of FIGS. 6A-6C, although the examples of FIGS. 7A-7C are described with respect to the user interacting with the generative content system via the generative content application, it should be understood that is for the sake of example and is not meant to be limiting. Rather, it should be understood that that the user may be able to access the generative content system via a web browser or other component(s) of the client device 110 (e.g., an automated assistant that integrates one or more aspects of the generative content system). Further, although certain natural language instructions are described herein, it should be understood that is for the sake of example and is not meant to be limiting. Rather, it should be understood that the personalized avatar can be controlled as desired and based on any natural language instructions provided by the user of the client device 110.

Turning now to FIG. 8, a block diagram of an example computing device 810 that may optionally be utilized to perform one or more aspects of techniques described herein. In some implementations, one or more of a client device, remote system component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in FIG. 1.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving vision data that captures a user, the vision data being generated via one or more vision components of a client device of the user; generating, based on the vision data that captures the user, a personalized avatar of the user, the personalized avatar of the user including at least a three-dimensional representation the user; receiving natural language instructions for controlling the personalized avatar of the user, the natural language instructions being received at the client device of the user; processing, using a generative model (GM), GM input to generate GM output, the GM input including at least an indication of the personalized avatar of the user and the natural language instructions for controlling the personalized avatar of the user; determining, based on the GM output, generative data, the generative data characterizing the personalized avatar of the user performing a sequence of actions defined by the natural language instructions for controlling the personalized avatar of the user; and causing the generative data, that characterizes the personalized avatar of the user performing the sequence of actions defined by the natural language instructions for controlling the personalized avatar of the user, to be rendered at the client device of the user or an additional client device of the user or an additional user.

These and other implementations of technology disclosed herein can optionally include one or more of the following features.

In some implementations, generating the personalized avatar of the user can include: generating, based on the vision data that captures the user, the three-dimensional representation of the user; generating, based on the three-dimensional representation of the user, an embedding that corresponds to the three-dimensional representation of the user; and mapping the embedding that corresponds to the three-dimensional representation of the user to a generic avatar to generate the personalized avatar of the user.

In some versions of those implementations, generating the embedding that corresponds to the three-dimensional representation of the user can include: processing, using the GM or an additional GM that is in addition to the GM, the vision data that captures the user to generate the embedding that corresponds to the three-dimensional representation of the user.

In additional or alternative versions of those implementations, generating the embedding that corresponds to the three-dimensional representation of the user can include: processing, using an additional machine learning (ML) model that is in addition to the GM, the vision data that captures the user to generate the embedding that corresponds to the three-dimensional representation of the user.

In some implementations, the vision data that captures the user can be the three-dimensional representation of the user, and generating the personalized avatar of the user can include: generating, based on the three-dimensional representation of the user, an embedding that corresponds to the three-dimensional representation of the user; and mapping the embedding that corresponds to the three-dimensional representation of the user to a generic avatar to generate the personalized avatar of the user.

In some implementations, the method can further include, prior to receiving the vision data that captures the user, training the GM. Training the GM can include: obtaining a plurality of training instances to be utilized in training the GM, each of the plurality of training instances including training natural language instructions and a training three-dimensional representation of a human performing a sequence of training actions defined by the training natural language instructions; and training, based on the plurality of training instances, the GM.

In some versions of those implementations, training the GM based on a given training instance, of the plurality of training instances, can include: processing, using the GM, at least the training natural language instructions and an indication of the training three-dimensional representation of the human, of the given training instance; and updating, based on processing the training natural language instructions and the indication of the training three-dimensional representation of the human, the GM.

In additional or alternative versions of those implementations, the method can further include, prior to receiving the vision data that captures the user, but subsequent to training the GM: obtaining a plurality of supervised fine-tuning instances to be utilized in supervised fine-tuning the GM, each of the plurality of supervised fine-tuning instances including supervised fine-tuning natural language instructions, a supervised fine-tuning three-dimensional representation of the human or an additional human performing a sequence of supervised fine-tuning actions defined by the supervised fine-tuning natural language instructions, and a supervised fine-tuning attention signal; and supervised fine-tuning, based on the plurality of supervised fine-tuning instances, the GM.

In some further versions of those implementations, supervised fine-tuning the GM based on a given supervised fine-tuning instance, of the plurality of supervised fine-tuning instances, can include: processing, using the GM, at least the supervised fine-tuning natural language instructions and an indication of the supervised fine-tuning three-dimensional representation of the human or the additional human, of the given supervised fine-tuning instance, to generate predicted generative data characterizing a generic avatar, that is generated based on the supervised fine-tuning three-dimensional representation of the human or the additional human, performing a predicted sequence of supervised fine-tuning actions that is predicted to correspond to the sequence of supervised fine-tuning actions defined by the supervised fine-tuning natural language instructions; generating, based on comparing features of the predicted generative data characterizing the generic avatar performing the predicted sequence of supervised fine-tuning actions that is predicted to correspond to the sequence of supervised fine-tuning actions defined by the supervised fine-tuning natural language instructions to features of ground truth data that captures the human or additional human performing the sequence of supervised fine-tuning actions defined by the supervised fine-tuning natural language instructions, one or more losses; and updating, based on the one or more losses, the GM.

In some additional or alternative further versions of those implementations, the sequence of supervised fine-tuning actions defined by the supervised fine-tuning natural language instructions can include one or more of: facial expressions to be made by the generic avatar, a transition between facial expressions to be made by the generic avatar, movements to be made by the generic avatar, a transition between movements to be made by the generic avatar, or spoken utterances to be spoken by the generic avatar.

In yet further versions of those implementations, the sequence of supervised fine-tuning actions defined by the supervised fine-tuning natural language instructions can include the facial expressions to be made by the generic avatar and/or the transition between the facial expressions to be made by the generic avatar, and the supervised fine-tuning attention signal can attention the GM, during the supervised fine-tuning, to facial movements made by the generic avatar and/or the transition between the facial expressions made by the generic avatar.

In additional or alternative yet further versions of those implementations, the sequence of supervised fine-tuning actions defined by the supervised fine-tuning natural language instructions can include the movements to be made by the generic avatar and/or the transition between the movements to be made by the generic avatar, and the supervised fine-tuning attention signal can attention the GM, during the supervised fine-tuning, to articulation of appendages during the movements made by the generic avatar and/or the transition between the movements made by the generic avatar.

In additional or alternative yet further versions of those implementations, the sequence of supervised fine-tuning actions defined by the supervised fine-tuning natural language instructions can include the spoken utterances to be spoken by the generic avatar, and the supervised fine-tuning attention signal can attention the GM, during the supervised fine-tuning, to mouth movements and/or facial movements while the spoken utterances are spoken by the generic avatar.

In additional or alternative versions of those implementations, the method can further include, prior to receiving the vision data that captures the user, but subsequent to training the GM: receiving reinforcement learning from human feedback (RLHF) natural language instructions for controlling a generic avatar, the RLHF natural language instructions being generated based on developer free-form natural language input received at a developer client device of a developer; processing, using the GM, RLHF GM input to generate RLHF GM output, the RLHF GM input including at least an indication of the generic avatar and the RLHF natural language instructions for controlling the generic avatar; determining, based on the RLHF GM output, generative RLHF data, the generative RLHF data characterizing the generic avatar performing a sequence of actions defined by the RLHF natural language instructions for controlling the generic avatar; causing the generative RLHF data, that characterizes the generic avatar performing the sequence of actions defined by the RLHF natural language instructions for controlling the generic avatar, to be rendered at the developer client device; receiving, from the developer, developer feedback with respect to the generative RLHF data that characterizes the generic avatar performing a sequence of actions defined by the RLHF natural language instructions for controlling the generic avatar; generating, using a reward model, a reward for the GM and based on the developer feedback; and updating, based on the reward, the GM.

In some implementations, the method can further include, prior to generating the personalized avatar of the user: determining whether the user is authorized to generate the personalized avatar. Generating the personalized avatar of the user can be in response to determining that the user is authorized to generate the personalized avatar.

In some versions of those implementations, determining whether the user is authorized to generate the personalized avatar can be based on biometric data of the user.

In some implementations, the method can further include: receiving free-form natural language input, the free-form natural language input being received at the client device of the user, and the free-form natural language input modifying an appearance of the personalized avatar of the user; and modifying, based on the free-form natural language input, the appearance of the personalized avatar of the user.

In some implementations, the sequence of actions defined by the natural language instructions for controlling the personalized avatar of the user can include: facial expressions to be made by the personalized avatar, a transition between facial expressions to be made by the personalized avatar, movements to be made by the personalized avatar, a transition between movements to be made by the personalized avatar, or spoken utterances to be spoken by the personalized avatar.

In some implementations, the natural language instructions for controlling the personalized avatar can be determined based on free-form natural language input that is received at the client device of the user.

In some implementations, the natural language instructions for controlling the personalized avatar can be determined based on a document that is provided at the client device of the user.

In some implementations, the generative data can include one or more of: generative vision data, or generative audio data.

In some versions of those implementations, the generative data can include the generative vision data, and causing the generative data to be rendered at the client device of the user or the additional client device of the user or the additional user can include causing the generative vision data to be visually rendered at the client device of the user or the additional client device of the user or the additional user.

In some further versions of those implementations, the generative data can further include the generative audio data, and causing the generative data to be rendered at the client device of the user or the additional client device of the user or the additional user can further include causing the generative audio data to be audibly rendered at the client device of the user or the additional client device of the user or the additional user.

In additional or alternative versions of those implementations, the generative data can include the generative audio data, and causing the generative data to be rendered at the client device of the user or the additional client device of the user or the additional user can include causing the generative audio data to be audibly rendered at the client device of the user or the additional client device of the user or the additional user.

In some further versions of those implementations, the generative data can further include the generative vision data, and causing the generative data to be rendered at the client device of the user or the additional client device of the user or the additional user can further include causing the generative vision data to be visually rendered at the client device of the user or the additional client device of the user or the additional user.

In some implementations, the generative data can include both of: generative vision data, or generative audio data.

In some versions of those implementations, the generative vision data and the generative audio data can be generated in a synchronized manner.

In some implementations, a method implemented by one or more processors is provided, and includes training a generative model (GM).

Training the GM includes: obtaining a plurality of training instances to be utilized in training the GM, each of the plurality of training instances including training natural language instructions and a training three-dimensional representation of a human performing a sequence of training actions defined by the training natural language instructions; processing, using the GM, at least the training natural language instructions and an indication of the training three-dimensional representation of the human, of the given training instance; and updating, based on processing the training natural language instructions and the indication of the training three-dimensional representation of the human, the GM. The method can further include subsequent to training the GM, supervised fine-tuning the GM. Supervised fine-tuning the GM can include: obtaining a plurality of supervised fine-tuning instances to be utilized in supervised fine-tuning the GM, each of the plurality of supervised fine-tuning instances including at least a supervised fine-tuning natural language instructions and a supervised fine-tuning three-dimensional representation of the human or an additional human performing a sequence of supervised fine-tuning actions defined by the supervised fine-tuning natural language instructions; processing, using the GM, at least the supervised fine-tuning natural language instructions and an indication of the supervised fine-tuning three-dimensional representation of the human or the additional human, of the supervised fine-tuning instance, to generate predicted generative data characterizing a generic avatar, that is generated based on the supervised fine-tuning three-dimensional representation of the human or the additional human, performing a predicted sequence of supervised fine-tuning actions that is predicted to correspond to the sequence of supervised fine-tuning actions defined by the supervised fine-tuning natural language instructions; generating, based on comparing features of the predicted generative data characterizing the generic avatar performing the predicted sequence of supervised fine-tuning actions that is predicted to correspond to the sequence of supervised fine-tuning actions defined by the supervised fine-tuning natural language instructions to features of ground truth data that captures the human or additional human performing the sequence of supervised fine-tuning actions defined by the supervised fine-tuning natural language instructions, one or more losses; and updating, based on the one or more losses, the GM. The method further includes subsequent to supervised fine-tuning the GM, causing the GM to be deployed for utilization in generating generative data characterizing a personalized avatar of a user performing a sequence of actions defined by natural language instructions for controlling the personalized avatar of the user.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving vision data that captures a user, the vision data being generated via one or more vision components of a client device of the user;
generating, based on the vision data that captures the user, a personalized avatar of the user, the personalized avatar of the user including at least a three-dimensional representation the user;
receiving natural language instructions for controlling the personalized avatar of the user, the natural language instructions being received at the client device of the user;
processing, using a generative model (GM), GM input to generate GM output, the GM input including at least an indication of the personalized avatar of the user and the natural language instructions for controlling the personalized avatar of the user;
determining, based on the GM output, generative data, the generative data characterizing the personalized avatar of the user performing a sequence of actions defined by the natural language instructions for controlling the personalized avatar of the user; and
causing the generative data, that characterizes the personalized avatar of the user performing the sequence of actions defined by the natural language instructions for controlling the personalized avatar of the user, to be rendered at the client device of the user or an additional client device of the user or an additional user.

2. The method of claim 1, wherein generating the personalized avatar of the user comprises:
generating, based on the vision data that captures the user, the three-dimensional representation of the user;
generating, based on the three-dimensional representation of the user, an embedding that corresponds to the three-dimensional representation of the user; and
mapping the embedding that corresponds to the three-dimensional representation of the user to a generic avatar to generate the personalized avatar of the user.

3. The method of claim 2, wherein generating the embedding that corresponds to the three-dimensional representation of the user comprises:
processing, using the GM or an additional GM that is in addition to the GM, the vision data that captures the user to generate the embedding that corresponds to the three-dimensional representation of the user.

4. The method of claim 2, wherein generating the embedding that corresponds to the three-dimensional representation of the user comprises:
processing, using an additional machine learning (ML) model that is in addition to the GM, the vision data that captures the user to generate the embedding that corresponds to the three-dimensional representation of the user.

5. The method of claim 1, wherein the vision data that captures the user is the three-dimensional representation of the user, and wherein generating the personalized avatar of the user comprises:
generating, based on the three-dimensional representation of the user, an embedding that corresponds to the three-dimensional representation of the user; and
mapping the embedding that corresponds to the three-dimensional representation of the user to a generic avatar to generate the personalized avatar of the user.

6. The method of claim 1, further comprising:
prior to receiving the vision data that captures the user, training the GM, wherein training the GM comprises:
obtaining a plurality of training instances to be utilized in training the GM, each of the plurality of training instances including training natural language instructions and a training three-dimensional representation of a human performing a sequence of training actions defined by the training natural language instructions; and
training, based on the plurality of training instances, the GM.

7. The method of claim 6, wherein training the GM based on a given training instance, of the plurality of training instances, comprises:
processing, using the GM, at least the training natural language instructions and an indication of the training three-dimensional representation of the human, of the given training instance; and
updating, based on processing the training natural language instructions and the indication of the training three-dimensional representation of the human, the GM.

8. The method of claim 6, further comprising:
prior to receiving the vision data that captures the user, but subsequent to training the GM:
obtaining a plurality of supervised fine-tuning instances to be utilized in supervised fine-tuning the GM, each of the plurality of supervised fine-tuning instances including supervised fine-tuning natural language instructions, a supervised fine-tuning three-dimensional representation of the human or an additional human performing a sequence of supervised fine-tuning actions defined by the supervised fine-tuning natural language instructions, and a supervised fine-tuning attention signal; and
supervised fine-tuning, based on the plurality of supervised fine-tuning instances, the GM.

9. The method of claim 8, wherein supervised fine-tuning the GM based on a given supervised fine-tuning instance, of the plurality of supervised fine-tuning instances, comprises:
processing, using the GM, at least the supervised fine-tuning natural language instructions and an indication of the supervised fine-tuning three-dimensional representation of the human or the additional human, of the given supervised fine-tuning instance, to generate predicted generative data characterizing a generic avatar, that is generated based on the supervised fine-tuning three-dimensional representation of the human or the additional human, performing a predicted sequence of supervised fine-tuning actions that is predicted to correspond to the sequence of supervised fine-tuning actions defined by the supervised fine-tuning natural language instructions;
generating, based on comparing features of the predicted generative data characterizing the generic avatar performing the predicted sequence of supervised fine-tuning actions that is predicted to correspond to the sequence of supervised fine-tuning actions defined by the supervised fine-tuning natural language instructions to features of ground truth data that captures the human or additional human performing the sequence of supervised fine-tuning actions defined by the supervised fine-tuning natural language instructions, one or more losses; and
updating, based on the one or more losses, the GM.

10. The method of claim 8, wherein the sequence of supervised fine-tuning actions defined by the supervised fine-tuning natural language instructions comprise one or more of:
facial expressions to be made by the generic avatar,
a transition between facial expressions to be made by the generic avatar,
movements to be made by the generic avatar,
a transition between movements to be made by the generic avatar, or
spoken utterances to be spoken by the generic avatar.

11. The method of claim 10,
wherein the sequence of supervised fine-tuning actions defined by the supervised fine-tuning natural language instructions comprise the facial expressions to be made by the generic avatar and/or the transition between the facial expressions to be made by the generic avatar, and
wherein the supervised fine-tuning attention signal attentions the GM, during the supervised fine-tuning, to facial movements made by the generic avatar and/or the transition between the facial expressions made by the generic avatar.

12. The method of claim 10,
wherein the sequence of supervised fine-tuning actions defined by the supervised fine-tuning natural language instructions comprise the movements to be made by the generic avatar and/or the transition between the movements to be made by the generic avatar, and
wherein the supervised fine-tuning attention signal attentions the GM, during the supervised fine-tuning, to articulation of appendages during the movements made by the generic avatar and/or the transition between the movements made by the generic avatar.

13. The method of claim 10,
wherein the sequence of supervised fine-tuning actions defined by the supervised fine-tuning natural language instructions comprise the spoken utterances to be spoken by the generic avatar, and
wherein the supervised fine-tuning attention signal attentions the GM, during the supervised fine-tuning, to mouth movements and/or facial movements while the spoken utterances are spoken by the generic avatar.

14. The method of claim 6, further comprising:
prior to receiving the vision data that captures the user, but subsequent to training the GM:
receiving reinforcement learning from human feedback (RLHF) natural language instructions for controlling a generic avatar, the RLHF natural language instructions being generated based on developer free-form natural language input received at a developer client device of a developer;
processing, using the GM, RLHF GM input to generate RLHF GM output, the RLHF GM input including at least an indication of the generic avatar and the RLHF natural language instructions for controlling the generic avatar;
determining, based on the RLHF GM output, generative RLHF data, the generative RLHF data characterizing the generic avatar performing a sequence of actions defined by the RLHF natural language instructions for controlling the generic avatar;
causing the generative RLHF data, that characterizes the generic avatar performing the sequence of actions defined by the RLHF natural language instructions for controlling the generic avatar, to be rendered at the developer client device;
receiving, from the developer, developer feedback with respect to the generative RLHF data that characterizes the generic avatar performing a sequence of actions defined by the RLHF natural language instructions for controlling the generic avatar;
generating, using a reward model, a reward for the GM and based on the developer feedback; and
updating, based on the reward, the GM.

15. The method of claim 1, further comprising:
prior to generating the personalized avatar of the user:
determining whether the user is authorized to generate the personalized avatar; and
wherein generating the personalized avatar of the user is in response to determining that the user is authorized to generate the personalized avatar.

16. The method of claim 15, wherein determining whether the user is authorized to generate the personalized avatar is based on biometric data of the user.

17. The method of claim 1, further comprising:
receiving free-form natural language input, the free-form natural language input being received at the client device of the user, and the free-form natural language input modifying an appearance of the personalized avatar of the user; and
modifying, based on the free-form natural language input, the appearance of the personalized avatar of the user.

18. The method of claim 1, wherein the sequence of actions defined by the natural language instructions for controlling the personalized avatar of the user comprise:
facial expressions to be made by the personalized avatar,
a transition between facial expressions to be made by the personalized avatar,
movements to be made by the personalized avatar,
a transition between movements to be made by the personalized avatar, or
spoken utterances to be spoken by the personalized avatar.

19. A system comprising:
at least one processor; and
memory storing instructions that, when executed, cause the at least one processor to be operable to:
receive vision data that captures a user, the vision data being generated via one or more vision components of a client device of the user;
generate, based on the vision data that captures the user, a personalized avatar of the user, the personalized avatar of the user including at least a three-dimensional representation the user;
receive natural language instructions for controlling the personalized avatar of the user, the natural language instructions being received at the client device of the user;
process, using a generative model (GM), GM input to generate GM output, the GM input including at least an indication of the personalized avatar of the user and the natural language instructions for controlling the personalized avatar of the user;
determine, based on the GM output, generative data, the generative data characterizing the personalized avatar of the user performing a sequence of actions defined by the natural language instructions for controlling the personalized avatar of the user; and
cause the generative data, that characterizes the personalized avatar of the user performing the sequence of actions defined by the natural language instructions for controlling the personalized avatar of the user, to be rendered at the client device of the user or an additional client device of the user or an additional user.

20. A non-transitory computer-readable storage medium storing instructions that, when executed by at least one processor, cause the at least one processor to be operable to perform operations, the operations comprising:
receiving vision data that captures a user, the vision data being generated via one or more vision components of a client device of the user;
generating, based on the vision data that captures the user, a personalized avatar of the user, the personalized avatar of the user including at least a three-dimensional representation the user;
receiving natural language instructions for controlling the personalized avatar of the user, the natural language instructions being received at the client device of the user;
processing, using a generative model (GM), GM input to generate GM output, the GM input including at least an indication of the personalized avatar of the user and the natural language instructions for controlling the personalized avatar of the user;
determining, based on the GM output, generative data, the generative data characterizing the personalized avatar of the user performing a sequence of actions defined by the natural language instructions for controlling the personalized avatar of the user; and
causing the generative data, that characterizes the personalized avatar of the user performing the sequence of actions defined by the natural language instructions for controlling the personalized avatar of the user, to be rendered at the client device of the user or an additional client device of the user or an additional user.
